(19) United States
(12) Patent Application Publication
(10) Pub. No.: US 2021/0256174 A1
(43) Pub. Date: Aug. 19, 2021

(54) COMPUTER AIDED SYSTEMS AND METHODS FOR CREATING CUSTOM PRODUCTS

(71) Applicant: Best Apps, LLC, Miami Beach, FL (US)

(72) Inventors: Michael Bowen, Los Angeles, CA (US); Linden D. Nelson, Miami Beach, FL (US)

(21) Appl. No.: 17/171,650

(22) Filed: Feb. 9, 2021

Related U.S. Application Data
(60) Provisional application No. 62/976,192, filed on Feb. 13, 2020.

(51) Int. Cl. G06F 30/12; G06K 9/00; G06N 3/04

(52) U.S. Cl. CPC G06F 30/12; G06F 2111/02; G06N 3/04; G06K 9/00288

(57) ABSTRACT

A computer-aided design (CAD) system enables physical articles to be customized via printing or embroidering and enables digital content to be customized and electronically shared. A CAD user interface may be generated that includes an image of a model of an article of manufacture and user customizable design areas that are graphically indicated on the image corresponding to the model. A design customization user interface may be provided enabling a user to access a template comprising one or more design areas for use in object customization. The user may be enabled to access images of the user and images of performers at a venue, taken by computer controlled cameras, that may be used to customize the object using the template. Manufacturing instructions corresponding to the user customizations may be transmitted to a printing system using a file that includes location, rotation, and/or scale data.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 1 CFR 1.57.

### BACKGROUND

The present invention is generally related to computer aided design and manufacture of custom products.

### DESCRIPTION OF THE RELATED ART

Computer-Aided Design (CAD) systems are conventionally used to design articles of manufacture. However, such conventional CAD systems often have overly difficult to use user interfaces, do not adequately ensure compliance with manufacturing processes, and do not provide adequate mechanisms for a manufacturer to provide flexibility for users to customize articles of manufacture.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An aspect of the disclosure related to a computer-aided design system enables physical articles to be customized via printing or embroidering and enables digital content to be customized and electronically shared. A user interface may be generated that includes an image of a model of an article of manufacture and user customizable design areas that are graphically indicated on the image corresponding to the model. A design customization user interface may be provided enabling a user to access a template comprising one or more design areas for use in object customization. The user may be enabled to access images of the user and images of performers at a venue that may be used to customize the object using the template. Manufacturing instructions corresponding to the user customizations may be transmitted to a printing system using a file that includes location, rotation, and/or scale data.

An aspect of the present disclosure relates to a computer-aided design (CAD) computer system comprising: a computing device; a network interface; a non-transitory data media configured to store instructions that when executed by the computing device, cause the computing device to perform operations comprising: detect a user's presence at a venue; determine a location associated with the user at the venue; orient one or more cameras to view the determined location associated with the user at the venue; capture an image of the determined location associated with the user; capture images of one or more performers at the venue; enable the user to access the image of the determined location associated with the user and images of one or more performers at the venue via a CAD customization interface; provide, for display on a device of the user, a design customization user interface enabling the user to access a first template comprising a plurality of design areas for use in object customization; enable the user to access the image of the determined location associated with the user and images of one or more performers at the venue via the design customization user interface; and enable the user to customize an object via the design customization user interface using the template, the image of the determined location associated with the user, and at least one performer image.

An aspect of the present disclosure relates to a computer implemented method, the method comprising: detecting a user's presence at a venue; determining a location associated with the user at the venue; capturing an image of the determined location associated with the user; capturing images of one or more performers at the venue; enabling the user to access the image of the determined location associated with the user and images of one or more performers at the venue via an object customization interface displayed on a user device; enabling the user to access a first template comprising one or more design areas for use in object customization; enable the user to access the image of the determined location associated with the user and images of one or more performers at the venue via the object customization interface; and enable the user to customize an object via the object customization interface using the template, the image of the determined location associated with the user, and at least one performer image.

### BRIEF DESCRIPTION OF THE DRAWINGS

Embodiments will now be described with reference to the drawings summarized below. Throughout the drawings, reference numbers may be re-used to indicate correspondence between referenced elements. The drawings are provided to illustrate example embodiments described herein and are not intended to limit the scope of the disclosure.

FIG. 1A is a block diagram illustrating an example embodiment of an operating environment.

FIG. 1B is a block diagram illustrating an embodiment of example components of a computer aided design (CAD) computing system capable of providing product customization services.

FIG. 1C is a block diagram illustrating an embodiment of example components of a venue system.

FIG. 2 illustrate an example user interface.

FIG. 3 illustrates an example venue including image capture device.

FIG. 4 illustrates an example image capture process.

FIG. 5 illustrates an example item custom process.

### DESCRIPTION

Systems and methods are described that provide computer aided design of customized items. Non-limiting examples of such items may include t-shirts, hoodies, shirts, jackets, dresses, pants, glasses, phone cases, laptop skins, backpacks, laptop cases, tablet cases, hairbands, wristbands, jewelry, digital content, and the like. Techniques, processes and user interfaces are disclosed that enable more efficient and accurate generation, editing, and printing or embroidering of design elements. Because the resulting customized items will more closely reflect user-desired customizations, there may be less wastage of materials (e.g., item fabric, ink, etc.), as there will be fewer defective or unsatisfactory customized items.

An aspect of the disclosure relates to enabling a user to utilize photographs of the user automatically captured at an event (e.g., a game, an athletic event, a concert, a play, a play, a speech by a politician or celebrity, a live taping of a television show, and/or the like) by computer controlled cameras to customize an object, optionally in conjunction with photographs of performers at the event.

An aspect of the disclosure relates to detecting the presence of a user at a venue and determining and/or tracking the location associated with the user using local and/or remote system(s). In addition, the location of one or more performers at the venue may be detected and tracked. Unless the context indicates otherwise, the phrase “performer” may include athletes (e.g., members of a sports team or individual athletes), musical performers, actors, politicians, magicians, circus animals, non-living objects that may be of significant interest at the venue (e.g., mobile robots, racing vehicles, monster trucks, and/or other inanimate objects), and/or the like.

Using the determined user location, computer-controlled cameras at the venue may be controlled to point at and capture images (still and/or video images) of the user. For example, a computer-controlled camera may be gimbal-mounted and a computer-controlled motor may rotate the camera to point at a desired angle. The camera may include a computer-controlled lens for focusing and/or zooming purposes.

The images of the user may be captured at random times and/or captured in response to a detected occurrence at the venue. For example, a detected occurrence may be a basketball player driving towards a basket or a football player running to an end zone. By way of further example, a detected occurrence may be the arrival of a musical performer on stage.

Similarly, the computer-controlled cameras at the venue may be controlled to point at and capture images (still and/or video images) of one or more performers. The images of the performer may be captured at random times and/or captured in response to a detected occurrence at the venue, such as those described above. Optionally, the number of images of a performer captured at the venue may be based on part on a determined popularity of the performer, which may indicate the likelihood that users will want to customize objects using the image of the performer.

For example, the performer popularity may be determined from one or more sources, such as the number of items customized using the performer's image over a specified period of time, the number of users at the event who have identified the performer as a preferred performer in their profiles, the number of users overall who have identified the performer as a preferred performer in their profiles, the number of mentions of the performer over a specified period of time on one more social networking sites (e.g., microblog sites, image sharing sites, and/or the like), the volume level of applause when the performer performs, and/or the like.

Once the images of the user and performer(s) are captured during the event at the venue, a notification including some or all of the user images may be transmitted to a user device (e.g., as image files or as links to the images which may be stored elsewhere, such as a cloud-based storage system). The notification may include a link or call to a computer aided design (CAD) system.

The user may utilize the CAD system to select an object to customize (e.g., t-shirts, hoodies, shirts, jackets, dresses, pants, glasses, phone cases, laptop skins, backpacks, laptop cases, tablet cases, hairbands, wristbands, jewelry, digital content, and the like) from an interactive catalog of objects, and may then customize the object using the images of the user taken during the event at the venue and images of the performer(s) taken during the event at the venue. Optionally, other content items may be provided as well which may be used to customize and object (e.g., images of performers that were not taken at the venue, team or other logos, graphics of frames, text, etc.).

As will be described in greater detail herein, optionally, a template may be provided via the CAD system. The template may be used to customize an object, where the template may optionally include non-removable or non-editable design elements (e.g., text, graphics, logos, photographs, etc.), removable or editable design elements, and where the template may define where images of the user or performers may be placed in the template.

Where the customized object is a digital object (e.g., a displayable electronic image customized by the user), the user-customized object may be transmitted to and displayed by a display (e.g., a large screen display at the venue during the event, such as a scoreboard display, displays flanking a stage, and/or other displays).

Optionally, use of the images of the performer taken during the event at the venue for object customization purposes may be restricted to those users that have been determined to have attended the event (e.g., based on a scan of a physical or electronic ticket or a biometric scan of the user, such as facial recognition, eye scan, fingerprint scan, electronic signal from a user device). Optionally, use of the images of the users and/or of the performer for object customization may be restricted to a specified period of time (e.g., only during the event, within 2 days of the event, within 30 days of the event, within 1 year of the event, etc.).

Optionally, the CAD system may enable an item (e.g., a product) provider to submit (e.g., via an upload or by providing a link) one or more images of the item (e.g., a photograph or graphic image of the front, back, left side, right side, top view, bottom view, and/or interior view of the item) and/or portions of the item (e.g., left sleeve, right sleeve, shoe lace, strap, etc.) for posting to an online interactive catalog of one or more items. The CAD system may enable certain customization options to be enabled for users and may enable the definition of certain areas of the item which may or may not be customized by users.

An example CAD system may provide a user interface including a design area and a set of tools via which a product provider can specify and/or apply design elements (e.g., text, image, and/or a graphic design elements) to an object product, specify areas to which an end user may specify design elements to be applied (e.g., printed or embroidered), specify permitted end user modifications to a design element originally specified by the product provider (that the system may perform in response to an end user request), specify permitted design element types and characteristics that the system may apply to the product in response to an end user request.

Optionally, as noted above, the CAD system may provide predefined templates for customizing objects which the user may edit using the images of the user and the images of the performer. Optionally, rules may be defined that limit modifications the user may make to the template. Examples of CAD systems, and examples of such rules, and systems and methods for enforcing and implementing such rules are described in U.S. application Ser. No. 16/690,029, filed Nov. 20, 2019, titled COMPUTER AIDED SYSTEMS AND METHODS FOR CREATING CUSTOM PRODUCTS, now U.S. Pat. No. 10,922,449, the contents of which are incorporated herein in their entirety by reference.

Templates, including image templates, text templates, and templates that include both image(s) and text may be presented to an end-user to provide the end-user with a starting point for customization, thereby simplifying the customization process. A template, by way of example, may include text, a digital sticker (e.g., a licensed cartoon character image), a logo, an image of a person (e.g., images of the user, the venue, performers, and/or the like), etc. A template may be editable by the end-user in accordance with item provider and/or template provider restrictions.

For example, a user interface may be provided via which an item provider may specify which colors in a given image can or cannot be changed. By way of further example, a user interface may be provided via which an item provider may specify which portions of an image may or may not be edited. By way of still further example, a user interface may be provided via which an item provider may specify design element size change restrictions (e.g., a maximum and/or a minimum height or width), restrict adding one or more specified colors to a design element, restrict changes to design element orientation (e.g., maximum and/or minimum rotation angle), restrict changes to text content (e.g., prevent changes to one or more words in a text design element), restrict changes to a design template height/width ratio, restrict changes to one or more fonts, restrict the use of one or more effects (e.g., text curvature effects, 3D effects, etc.), and/or the like. By way of yet further example, a user interface may be provided via which a user may specify placement/movement restrictions for templates, images and/or text. By way of further example, a user interface may be provided via which a user may specify that certain text and/or image notifications (e.g., copyright notices, trademark notices) or logos may not be removed and/or altered. By way of additional example, a user interface may be provided via which a user may specify that the certain design elements may not be used together to customize an object. By way of further example, a user interface may be provided via which a user may specify that the certain types of design elements (e.g., images of alcohol, drugs, drug paraphernalia, religious symbols, celebrities, etc.) may not be used to customize an object.

Certain aspects of the disclosure will now be discussed with reference to the figures.

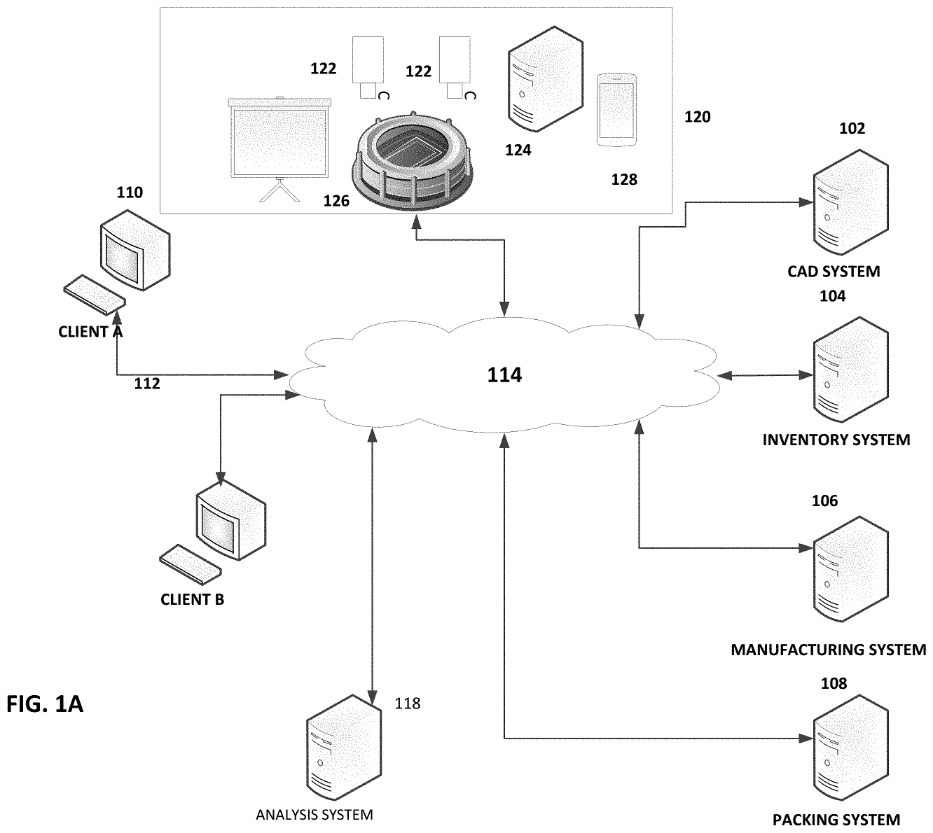

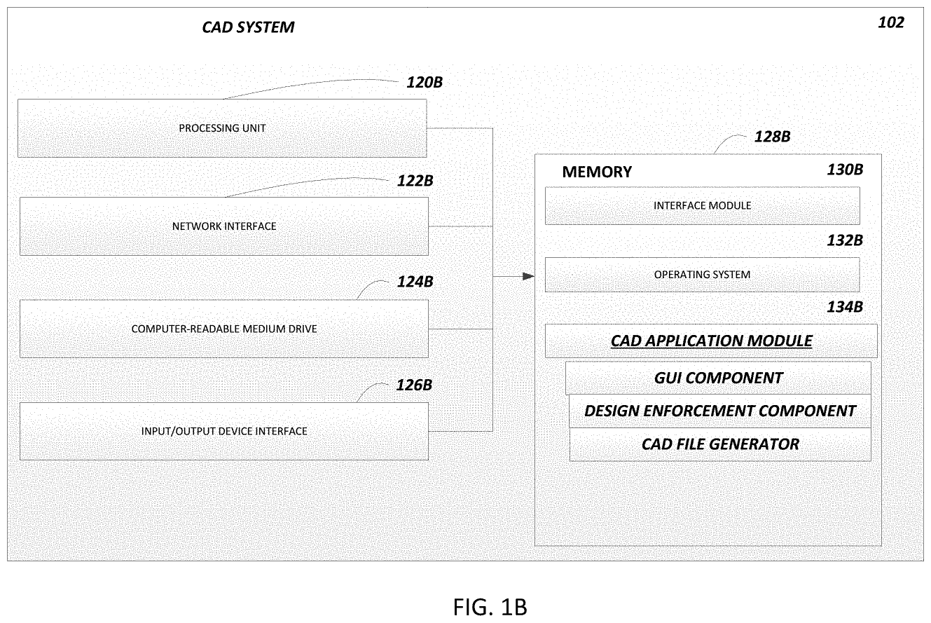

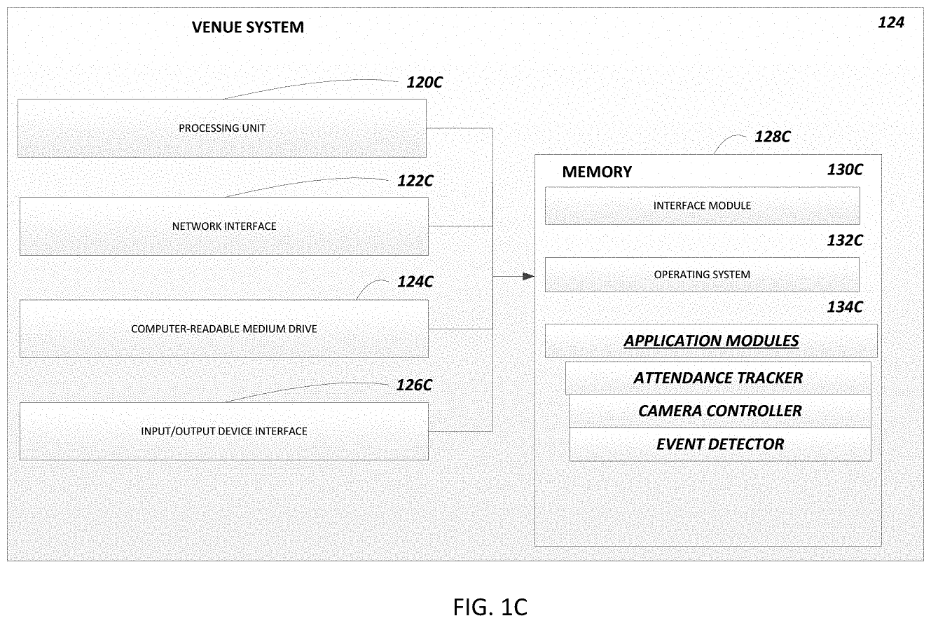

An example system architecture that may be utilized to provide computer aided design and manufacturing services will now be discussed with reference to FIG. 1A. The various systems and devices may communicate with each other over one or wired and/or wireless networks 114. In the illustrated embodiment, a computer aided design (CAD) system 102 may be hosted on one or more servers. The CAD system 102 may be cloud-based and may be accessed by one or more client 3rs 110, 112 (e.g., associated with an item provider or end user) and item provider terminals 105a-105n over a network 114 (e.g., the Internet, Ethernet, or other wide area or local area network). Client terminals may be able to share software applications, computing resources, and data storage provided by the CAD system 102.

The client terminals may be in the form of a desktop computer, laptop computer, tablet computer, mobile phone, smart television, dedicated CAD terminal, or other computing device. A client terminal may include user input and output devices, such a displays (touch or non-touch displays), speakers, microphones, trackpads, mice, pen input, printers, haptic feedback devices, cameras, and the like. A client terminal may include wireless and/or wired network interfaces via which the client terminal may communicate with the CAD system 102 over one or more networks. A client terminal may optionally include a local data store that may store CAD designs which may also be stored on, and synchronized with, a cloud data store.

User interfaces described herein are optionally configured to present user edits (e.g., edits to images, text, item colors, or the like) in real time as applied to an item image to thereby ensure enhanced accuracy, reduce the possibility of user error, and so make the customization process more efficient. The user interfaces may present controls and renderings to further ease the specification of customization permissions by item providers, and to ease customizations of items by end users.

Optionally, a version of the user interfaces described herein may be enhanced for use with a small screen (e.g., 4 to 8 inches diagonal), such as that of a mobile phone or small tablet computer. For example, the orientation of the controls may be relatively more vertical rather than horizontal to reflect the height/width ratio of typical mobile device display. Further, the user interfaces may utilize contextual controls that are displayed in response to an inferred user desire, rather than displaying a large number of tiny controls at the same time (which would make them hard to select or manipulate using a finger). For example, if a user touches an image template in a template gallery, it may be inferred that the user wants to add the image template to a previously selected item design area and to then edit the image template, and so the selected image template may be automatically rendered in real time on the selected item design area on a model/image of a product in association with permitted edit tools.

Further, optionally user interfaces described herein may enable a user to expand or shrink a design element using a multi-touch zoom gesture (where the user touches the screen with two fingers and moves the fingers apart) or a multi-touch pinch gesture (where the user touches the screen with two fingers and moves the fingers together) to further ease editing of a design element and ease specification of a design area or editing restrictions. Optionally, a user interface may enable a user to resize a design element using a one finger icon drag/pull.

Optionally, a resizing control may be provided which enables the user to quickly resize a design element to an appropriate size. For example, if an existing design element is sized for a shirt pocket, the resizing control may enable the user to instruct the system to automatically resize the design element for another selected area, such as a chest area or a sleeve area.

Optionally, user interfaces may be configured to respond to a user swipe gesture (e.g., a left or a right swipe gesture using one or more fingers) by replacing a currently displayed design element (e.g., a template) on an item model with another design element (e.g., another template in a set of templates). Optionally, if a user has edited a first design element and then used a swipe gesture to replace the design element with a second design element, some or all of the edits made to the first design element (e.g., height edit, width edit, color edit, or the like) may be automatically applied to the second design element.

Optionally, in response to a swipe gesture (e.g., an up or down swipe gesture) a user interface may display metadata related to the displayed item and/or item customizations (e.g., cost, shipping time, item size, etc.) or other notifications.

Optionally, in response to a gesture (e.g., an up/down or left/right swipe) the product on which the design element is displayed is changed. For example, if a design element is displayed on a model of a jacket, the gesture may cause the same design element (optionally with any user edits) to be displayed in real time on another item model (e.g., a t-shirt or a different jacket style) in place of the original jacket model.

The CAD system 102 may provide tools to graphically construct computer models of and to modify computer models of products such t-shirts, hoodies, shirts, jackets, dresses, pants, glasses, phone cases, laptop skins, backpacks, laptop cases, tablet cases, hairbands, wristbands, jewelry, and the like.

The CAD system 102 tools may include tools for specifying and/or applying design elements (e.g., text, image, and/or a graphic design elements) to a product, specify areas to which an end user may apply design elements, specify permitted end user modifications to a design element and/or specify permitted design element types and characteristics that the system may apply to the product in response to an end user request. Optionally, collaboration tools are provided that enable users (e.g., end users, or a graphic designer and an item provider) to collaborate with each other and/or the item provider on customizations for a given product.

The CAD system 102 may optionally generate, based on an end-user design or design modification, corresponding order forms and/or manufacturing instructions. Some or all of the information generated by the CAD system 102 may be provided to an inventory/ordering system 104, a manufacturing system 106, a packing/shipping system 108, and/or an analysis engine 118. Some are all of the foregoing systems may optionally be cloud based. Optionally, the CAD system 102, inventory/ordering system 104, manufacturing system 106, packing/shipping system 108, and/or analysis engine 118 may be the same system and may be operated by the same entity, or may be separate systems operated by separate entities.

Optionally some or all of the services provided by the CAD system 102, inventory/ordering system 104, manufacturing system 106, packing/shipping system 108, and/or analysis engine 118 may be accessed via one or more APIs by authorized third party systems. For example, a movie studio website may provide access to the services (including some or all the user interfaces) to enable visitors of their website to use logos and images of characters of the studio to customize physical and/or digital items. By way of further example, a third party CAD system used to customize physical and/or digital items may access the services to access restrictions and/or permissions (rules) specified for design elements that users of the third party CAD system are modifying or otherwise using. For example, the third party CAD system may generate a request for usage rules, where the request may identify the design element that a user wishes to use (e.g., customize, combine with other content, electronically distribute, print, etc.). The CAD system may generate a corresponding response to the query that includes usage rules. The third party CAD system may utilize the services to determine if a given modification or other use satisfies the rules.

The CAD system 102 may optionally generate directives in the form of manufacturing machine instructions for applying (e.g., printing or embroidering). For example, design files may be provided that include an image file (e.g., in raster graphics file format, such as a portable network graphics file) and screenshots of the user customized item. Optionally the image file may support RGB color spaces and/or non-RGB color spaces (e.g., CMYK color spaces). Optionally, the image file may be in SVG, PDF, GIF, Encapsulated PostScript, AutoCAD DFX, or ADOBE ILLUSTRATOR format. Optionally, one or more files may be compressed (e.g., losslessly compressed) and transmitted to the manufacturing system 106 in the form of a zip file, jar file or other file format. The manufacturing system 106 may then decompress the file using an appropriate decompression module.

The inventory/ordering system 104 may receive and process an order for a customized item, generate prices for a customized item (e.g., based on a base item price, the number of customizations, and/or the type of customizations), maintain a user shopping cart, and generally interact with a user ordering an item and managing the ordering process. The inventory/ordering system 104, when receiving an order for a customized item customized using the CAD system 102, may determine if the item being designed/modified is in stock, and order items that are below a specified threshold (e.g., zero or some number greater than zero).

The packing/shipping system 108 may generate packing instructions to efficiently package the items being shipped to the user. For example, the instructions may specify package sizes and which items are to be shipped in which package. The packing/shipping system 108 may further generate shipping labels and/or other shipping documents.

An analysis system 118 may be configured to analyze user modifications to design elements and/or user added or selected content (e.g., images and/or text) associated by the user with the design elements. The analysis system 118 may be configured to receive a query generated by the CAD system 102 and/or the venue system 124 that specifies one or more different feature types to be detected. The CAD system 102 may generate the query based at least in part on rules specified by a source of the design elements. The rules may indicate how a design element may be modified and what content may be used in conjunction with the design element (e.g., overlaying the design element, or directly to one side of the design element). The analysis system 118 may generate a likelihood indication/value as to whether a given feature type is present. The likelihood indication/value may be provided to the CAD system 102, which may determine, using such indication, whether or not the modification and/or associated user added or selected content may be used and/or shared by the user.

The analysis system 118 may utilize artificial intelligence and/or machine learning in performing text, image (e.g., using computer vision), and/or audio analysis to determine the likelihood that given a feature type is present (e.g., the presence of a face by performing face detection) and/or to perform face recognition. For example, the analysis system 118 may utilize a deep neural network (e.g., a convolutional deep neural network) and/or a matching engine in performing facial, image, text, and/or audio analysis.

A venue 120 may include a venue computer system 124 and one or more computer-controlled cameras 122 that may be controlled by the computer system 124. A given camera 122 may include one or more focusing sensors, imaging sensors, a control system, a lens motor to focus the camera on a desired target, one or more through-the-lens optical sensors, one or more lens arrays providing light metering (e.g., matrix metering, center-weighted metering, spot metering, and/or the like), a motor controlled aperture mechanism, a shutter, etc. It is understood that the functionality described as being performed by the venue computer system 124 may be performed by one or more other systems described herein or by still different systems and vice versa.

The venue 120 may include a display 126 (e.g., a large screen display many feet high and many feet across, such as a scoreboard display or a display flanking a stage) which may be connected (via a wired or wireless interface) to the computer system 124. The computer system 124 may transmit user-customized objects for display to the display 126, as well as other content, such as sports scores, news, and/or other content.

As described herein, the venue computer system 124 may track users entering the venue (e.g., by scanning physical or electronic tickets associated with the users), track user movements in the venue (e.g., by tracking the locations of user phones 128 or wearables, via facial recognition, or otherwise), determine what seat users are assigned to (e.g., by accessing ticket records that include user names, seating locations, mobile phone numbers/SMS addresses, email addresses, etc.), control the cameras to point at and take photographs of user seating areas, performers, and/or a venue, and optionally determine if a given user is in the user's seat prior to or after taking a photograph/video of the seating area.

The venue computer system 124 may provide images of users captured by the cameras to the CAD system, optionally in association with user data (e.g., name, email address, mobile phone number/SMS address). In addition, the venue computer system 124 may provide performer images captured by the cameras to the CAD system, optionally in association with performer data (e.g., name, team name, metadata describing/identifying the occurrence associated with the performer).

The venue computer system 124 may provide images of the venue captured by the cameras to the CAD system, optionally in association with venue data (e.g., the name of the venue, a section/area identifier, etc.).

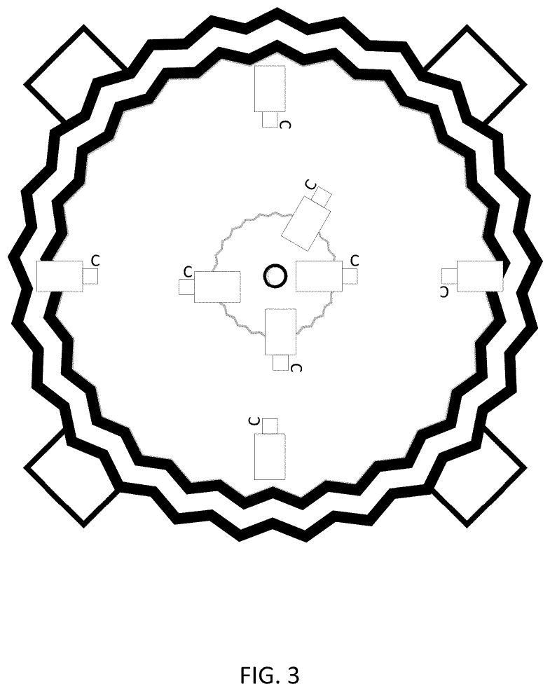

FIG. 3 illustrates the venue 120 with computer-controlled cameras pointing both inwardly from the venue perimeter and outwardly from a center support/platform.

FIG. 1B is a block diagram illustrating an embodiment of example components of the CAD system 102. The example CAD system 102 includes an arrangement of computer hardware and software components that may be used to implement aspects of the present disclosure. Those skilled in the art will appreciate that the example components may include more (or fewer) components than those depicted in FIG. 1B.

The CAD system 102 may include one or more processing units 120B (e.g., a general purpose process and/or a high speed graphics processor with integrated transform, lighting, triangle setup/clipping, and/or rendering engines), one or more network interfaces 122B, a non-transitory computer-readable medium drive 124B, and an input/output device interface 126B, all of which may communicate with one another by way of one or more communication buses. The network interface 124B may provide the CAD services with connectivity to one or more networks or computing systems. The processing unit 120B may thus receive information and instructions from other computing devices, systems, or services via a network. The processing unit 120B may also communicate to and from memory 12B4 and further provide output information via the input/output device interface 126B. The input/output device interface 126B may also accept input from one or more input devices, such as a keyboard, mouse, digital pen, touch screen, microphone, camera, etc.

The memory 128B may contain computer program instructions that the processing unit 120B may execute in order to implement one or more aspects of the present disclosure. The memory 120B generally includes RAM, ROM (and variants thereof, such as EEPROM) and/or other persistent or non-transitory computer-readable storage media. The memory 120B may store an operating system 132B that provides computer program instructions for use by the processing unit 120B in the general administration and operation of the CAD application module 134B, including it components. The memory 128B may store user accounts, including copies of a user's intellectual property assets (e.g., logos, brand names, photographs, graphics, animations, videos, sound files, stickers, tag lines, etc.) and groupings thereof (with associated group names). Optionally, in addition or instead, the intellectual property assets are stored remotely on a cloud based or other networked data store. The CAD system may receive images (e.g., still photographs or videos) that were captured using the computer-controlled cameras 122 of users, performers, and/or the venue from the venue system 124.

The copies of the intellectual property assets and captured images may optionally be stored in a relational database, an SQL database, a NOSQL database, or other database type. Because the assets may include BLOBs (binary large objects), such as videos and large images, which are difficult for conventional database to handle, some (e.g., BLOBs) or all of the assets may be stored in files and corresponding references may be stored in the database. The CAD application module components may include a GUI component that generates graphical user interfaces and processes user inputs, a design enforcement component to ensure that user designs do not violate respective permissions/restrictions, a CAD file generator that generates data files for an inputted user design, and/or an image generator that generates image data files for printing and/or sewing/embroidering machines.

The printing machines may utilize, by way of example, heat transfer vinyl, screen printing, direct to garment printing, sublimation printing, and/or transfer printing to print design elements on an item. By way of further example, embroidery machines may be used to embroider design elements on an item. The memory 128B may further include other information for implementing aspects of the present disclosure.

The memory 128B may include an interface module 130B. The interface module 130B can be configured to facilitate generating one or more interfaces through which a compatible computing device, may send to, or receive from, the CAD application module 134B data and designs.

FIG. 1C is a block diagram illustrating an embodiment of example components of the venue system 124. The example venue system 124 includes an arrangement of computer hardware and software components that may be used to implement aspects of the present disclosure. Those skilled in the art will appreciate that the example components may include more (or fewer) components than those depicted in FIG. 1C.

The venue system 124 may include one or more processing units 120C (e.g., a general purpose process and/or a high speed graphics processor with integrated transform, lighting, triangle setup/clipping, and/or rendering engines), one or more network interfaces 122C, a non-transitory computer-readable medium drive 124B, and an input/output device interface 126C, all of which may communicate with one another by way of one or more communication buses. The network interface 124C may provide the venue system services with connectivity to one or more networks or computing systems. The processing unit 120C may thus receive information and instructions from other computing devices, systems, or services via a network. The processing unit 120C may also communicate to and from memory 124C and further provide output information via the input/output device interface 126C. The input/output device interface 126C may also accept input from one or more input devices, such as a keyboard, mouse, digital pen, touch screen, microphone, camera, etc.

The memory 128C may contain computer program instructions that the processing unit 120C may execute in order to implement one or more aspects of the present disclosure. The memory 120C generally includes RAM, ROM (and variants thereof, such as EEPROM) and/or other persistent or non-transitory computer-readable storage media. The memory 120C may store an operating system 132C that provides computer program instructions for use by the processing unit 120C in the general administration and operation of the venue application module 134C, including it components. The memory 128C may store user accounts, including user names, email addresses, mobile phone numbers/SMS addresses, ticketing and seating data (which may include a specific seat identifier associated with a user ticket), performer and user images captured by the cameras 122, and copies of intellectual property assets (e.g., logos, brand names, photographs, graphics, animations, videos, sound files, stickers, tag lines, etc.) and groupings thereof (with associated group names). Optionally, in addition or instead, some or all of the user account data, photographs, videos, and/or intellectual property assets are stored remotely on a cloud based or other networked data store. The venue system 124 may receive and store images (e.g., still photographs or videos) of users and performers from the venue system 124 that were captured using the computer-controlled cameras 122.

The venue application module components may include a GUI component that generates graphical user interfaces and processes user inputs, an attendance tracker that tracks users entering and leaving a venue, an event detector that detects occurrences (e.g., a performer performing certain types of actions at the venue), and a camera controller (e.g., configured to point the camera at a desired location such as at a performer or user seating area).

The memory 128C may include an interface module 130C. The interface module 130C can be configured to facilitate generating one or more interfaces through which a compatible computing device, may send to, or receive from, the venue application module 134B data and designs.

The modules or components described above may also include additional modules or may be implemented by computing devices that may not be depicted in FIGS. 1A, 1B and 1C. For example, although the interface module 130B and the CAD application module 134B are identified in FIG. 1B as single modules, the modules may be implemented by two or more modules and in a distributed manner. By way of further example, the processing unit 120B or 120C may include a general purpose processor and a graphics processing unit (GPU). The CAD system 104 or venue system 124 may offload compute-intensive portions of the applications to the GPU, while other code may run on the general purpose processor. The GPU may include hundreds or thousands of core processors configured to process tasks in parallel. The GPU may include high speed memory dedicated for graphics processing tasks. As another example, the CAD system 104 and/or venue system 124 and their components can be implemented by network servers, application servers, cloud-base systems, database servers, combinations of the same, or the like, configured to facilitate data transmission to and from data stores, client terminals, and third party systems via one or more networks. Accordingly, the depictions of the modules are illustrative in nature.

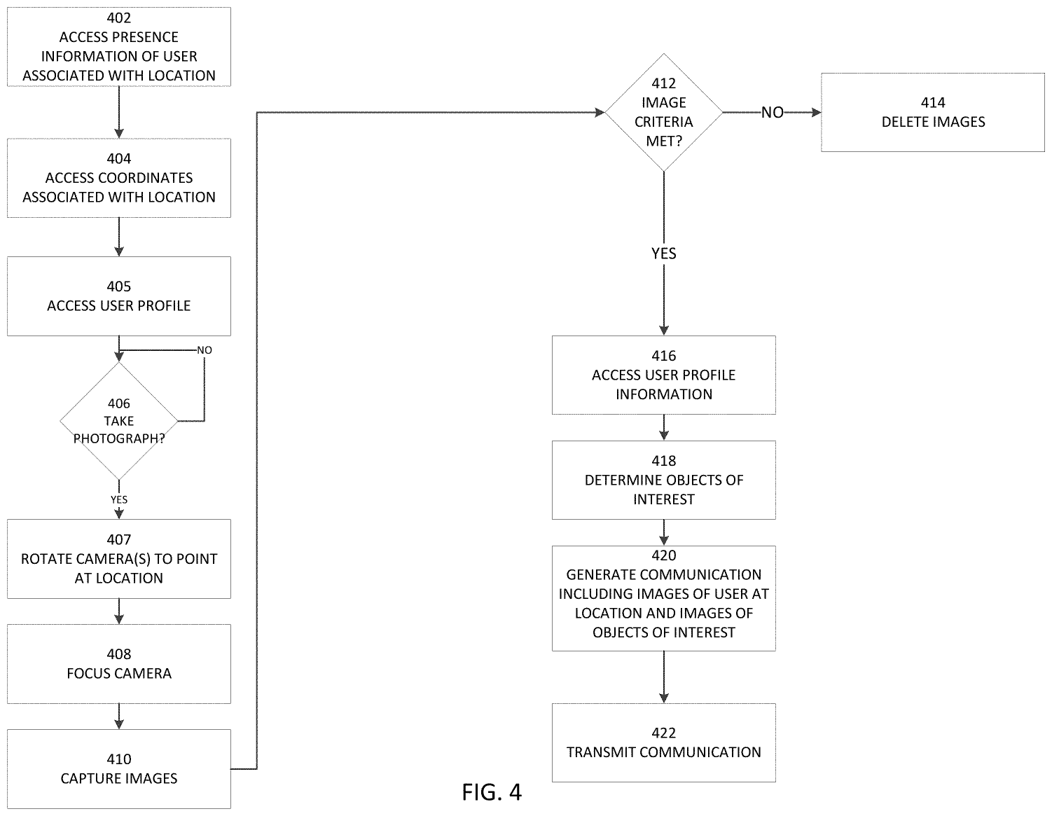

FIG. 4 illustrates an example process. At block 402, presence information for the user associated with a location is accessed. For example, when a user enters a venue, a user access token (e.g., physical or electronic ticket, fingerprint, facial features, etc.) may be scanned. The scanned token may be associated with a user record. The user record may include user seating information (e.g., section, row, seat number, etc.) which indicates where the user will be located once seated. At block 404, coordinate information associated with the location may be accessed (e.g., X, Y, Z coordinates with respect to a reference system) from a database that references venue seats or other locations to corresponding coordinates.

At block 405, the user's profile is accessed. The user's profile may include an authorization for the user's photograph to be captured at venue(s), the user's liked teams, the user's unliked teams, the user liked performers, the user's unliked performers, the user's preferred objects (e.g., t-shirts, mugs, hoodies, etc.), preferred templates, and/or the like.

At block 406, a determination may be made as to whether a photograph of the user is to be taken. The determination may be based on whether the user's profile provided authorization for such photograph, whether the user has been detected at the venue (e.g., had an access token scanned), whether an event (e.g., sporting event, concert, convention, etc.) scheduled to occur at the venue has started (e.g., based on the scheduled start time of the event or based on detection of the actual start of the event), whether an action/occurrence has occurred at the venue that the user's profile indicated the user was interested in (which may indicate that the user is likely to visibly react to such action/occurrence), action/occurrence has occurred at the venue that the viewers are generally interested in, detected or estimated lighting conditions at the user's location, and/or other data.

For example, the user's profile may indicate that the user is interested in/prefers having the user's image captured in response to a detected occurrence at the venue (where the captured image of the user may capture the user visibly reacting to the occurrence). For example, a detected occurrence may be a basketball player driving towards a basket or a football player running to an end zone. By way of further example, a detected occurrence may be the arrival of a musical performer on stage. Optionally, even if the user's profile does not expressly indicate an interest in such occurrences, an inference may be made that fans at the venue or generally interested in such occurrences, and so images of the user during such occurrence may be captured (e.g., where the user may be cheering, be waving hands in the air, may be laughing, etc.).

In response to determining that a photograph of the user is to be taken, at block 407 one or more venue cameras may be rotated to point to the user's location using the location coordinates, For example, motor commands may be provided to a gimbal on which the camera is mounted to rotate and angle the camera so that the camera is pointing at the user's location. The gimbal may be a 2 or 3-axis gimbal and may comprise a pivoted support that enables rotation of the camera in each axis.

At block 408, the venue cameras pointing at the user location is focused on the location. For example, the camera(s) may be focused on the user's seat or the user him/herself (e.g., the detected user's phone, whole body, limbs, etc.). As similarly discussed above, the camera may include one or more focusing sensors, an imaging sensor, a control system, a lens motor to focus the camera on a desired target. The camera may include a shutter, one or more through-the-lens optical sensors, a separate sensor array providing light metering. An autofocus sensor may measure relative focus by evaluating changes in contrast at its respective point in the image being imaged by the camera, which maximal contrast may correspond to maximal sharpness. In addition, the camera aperture may be automatically adjusted to control the brightness of the image that passes through the lens and falls on the image sensor.

At block 410, the image of the user and/or the user location is captured. At block 412, the captured image may be evaluated to determine if it meets certain criteria. For example, the image may be analyzed to determine if the face of a person is in the image and if the facial image is that of the user.

For example, captured image(s) of the user may be analyzed to determine if the user (or selected portions of the user, such as the user face) is present in the photograph and/or other image criteria are met. Optionally, in addition, the quality of the image may be analyzed. For example, blur, sharpness, noise, contrast, color hue, color saturation, composition (image symmetry, and image alignment (e.g., the concentration and orientation of edges and lines in the image)), lighting, and/or spatial envelope may be analyzed.

Examples of image analysis are as follows:

Sharpness may be determined using a high pass filter applied to the image, subtracting a blurred version of the image from the original, then a selected percentile pixel (e.g., in the range of 95^{th}-99^{th} pixel) in the resulting image may be calculated. An image may be determined to be sharp if the image contains a threshold amount of high frequency data.

Contrast may be measured as the range and standard deviations of a brightness histogram of the image.

Noise may be estimated by calculating a difference between the image and a median filtered version of the image. Optionally, adaptive methods may be utilized where the image data is iteratively filtered until a determined threshold of reduced signal accuracy is reached.

Motion blur may be estimated by convolving the image with one or more one-dimensional gaussian kernels at different orientations, and comparing the resulting image sharpness. An image blurred in only one direction will be sharper when convolved with a kernel in that direction than with a kernel in a perpendicular direction.

Color saturation may be determined using the mean of the saturation channel after the image is converted to HSV (Hue, Saturation, Value/Brigthness) space.

Hue may be determined by generating a histogram of hue values in the image, and measuring the amount of certain color components (e.g., blue, green, yellow, orange, etc.) in the image.

A, spatial envelope may be features used to classify scene. By way of illustration the “naturalness” of an image may be determined using a measurement of the distribution of edge orientations, where predominantly (e.g., greater than 60, 70, or 80%) horizontal edge orientations or predominantly vertical edge orientations may be less natural than an approximately even mix (e.g., where one orientation does predominate the other orientation by more than 10%, 20%, or 30%), and “roughness” (a measurement of the overall complexity of the image).

Optionally, prior to analyzing the image, the image may be preprocessed. For example, the image may be downscaled (e.g., by a factor in the range of 2 to 10) in either or both dimensions. Optionally, the image aspect ratio is maintained in the downscaling process. The downscaling may reduce the processing and memory resources needed to perform the analysis and may aid in certain types of analysis (e.g., sharpness). Optionally, a greyscale version of the downscaled image may be generated that may be used for certain non-color related analysis.

A neural network or other artificial engine may be utilized to detect the presence of a face in an image (face detection), and optionally a neural network or other artificial engine may be utilized to determine if a detected face in the image is the face of the user (facial identification).

An face detection system, comprising a neural network, may be used to detect the presence of a face in an image. The neural network model may be trained to recognize a face using a dataset of images of faces (e.g., tens, hundreds, or thousands of images of a given face of different people). Optionally, transfer learning may be used to reduce the amount of time needed to train the entire model. For example, an existing model (that has been trained on a related domain, such as image classification) may have its final layer(s) retrained to detect a given face. The training may proceed until the error (the loss) is below a specified threshold.

Optionally, in addition or instead, a face may be detected by extracting the image background (e.g., based on texture and boundary features), and distinguishing between certain specified faces and background using color histograms and histogram of oriented gradients (HOG) classifiers. The use of neural networks may be preferred in certain circumstances, as the forgoing process may be confused where sharp changes in lighting conditions cause sharp changes in skin color or with certain backgrounds.

Optionally, computer vision (e.g., employing a deep convolutional neural network (CNN)) is used to perform facial recognition. In addition, the CNN may be trained and used to classify various items and item characteristics. For example, the CNN may be trained and used to identify the ethnicity, age, sex, eye color, and/or hair color, of faces in an image. The CNN may also be trained to identify and classify objects in an image (e.g., cigarettes, bottles of alcohol, drug paraphernalia, religious objects, etc.).

As discussed above, optionally, prior to performing facial recognition, if an image (e.g., a photograph) is in color, the image may be converted to gray scale to reduce noise in the image. Optionally, an affine transformation, (a transformation that preserves collinearity (where points lying on a line initially still lie on a line after transformation) and ratios of distances) may be used to rotate a given face and make the position of the eyes, nose, and mouth for each face consistent.

For example, 34, 68, 136 or other number of facial landmarks may be used in affine transformation for feature detection, and the distances between those points may be measured and compared to the points found in an average face image. The image may then be rotated and transformed based on those points to normalize the face for comparison, and the image may optionally be reduced in size (e.g., 96×96, 128×128, 192×192, or other number of pixels) for input to a trained CNN. Optionally, a Gaussian blur operation may be applied to smooth the image while preserving important feature information. Optionally, an edge detector, such as a Sobel edge detector may be used to detect features (eyes, nose, mouth, ears, wrinkles, etc.). Optionally, principal component analysis may be performed to identify such features.

In particular, a deep convolutional neural network (CNN) model may be trained to identify matching faces from different photographs. The deep neural network may include an input layer, an output layer, and one or more levels of hidden layers between the input and output layers. The deep neural network may be configured as a feed forward network. The convolutional deep neural network may be configured with a shared-weights architecture and with translation invariance characteristics. The hidden layers may be configured as convolutional layers, pooling layers, fully connected layers and/or normalization layers. The convolutional deep neural network may be configured with pooling layers that combine outputs of neuron clusters at one layer into a single neuron in the next layer. Max pooling and/or average pooling may be utilized. Max pooling may utilize the maximum value from each of a cluster of neurons at the prior layer. Average pooling may utilize the average value from each of a cluster of neurons at the prior layer.

The CNN may be trained using image triplets. For example, an image triplet may include an anchor image, a positive image, and a negative image. The anchor image is of a person's face that has a known identity A. The positive image is another image of the face of person A. The negative image is an of a face of person B.

The CNN may compute feature vectors (sometimes referred to as “embeddings”) that quantify a given face in a given image. For example, 128-d embeddings may be calculated (a list of 128 real-valued numbers that quantify a face) for each face in the triplet of images. The CNN weights may be adjusted using a triplet loss function such that the respective calculated embeddings of the anchor image and positive image lie closer together, while at the same time, the calculated embeddings for the negative image lie father away from those of the anchor and positive images.

For example, the triplet loss function may be defined as:

Loss=max(d(a,p)−d(a,n)+margin,0)

Where the loss is minimized, thereby causing d(a,p) to be pushed towards zero, and to be greater than (d(a,p)+margin; and were the margin is the desired distance between the negative image embeddings and those of the anchor and positive images.

Optionally, instead of triplet loss function, a softmax cross entropy loss function may be used to adjust weights.

Using the foregoing techniques, the CNN may be trained to quantify faces and return highly discriminating embeddings that enable accurate face recognition.

If the image fails to satisfy the image criteria (indicating that the image is unsatisfactory), at block 414 the image may be deleted to reduce memory storage requirement and is optionally not transmitted to the user device to reduce network bandwidth usage and memory usage on the user device. Optionally instead, the image may be retained in memory (e.g., to further train the neural network or for other purposes).

If the image satisfied the image criteria, a block 416, user preferences may be accessed from the user's profile that indicate the event types (e.g., opening tip-off in a basketball game, touchdown in a football game, fireworks at a concert, etc.) or subjects (e.g., specific performers, such as specific athletes, teams, specific members of band, etc.). At block 418, the user preferences may be used to select which images of the event (aside from images of the user) the user may be interested in using to customize an object.

At block 420, a communication may be generated including images (or links to images) of the user that satisfied the criteria discussed above and image of objects (people, footballs, fireworks, etc.)/events that have been determined to be of interest to the user. At block 422 the communication may be transmitted to a destination associated with the user (e.g., a dedicated app hosted on the user device, an email address, a messaging app address, etc.) for display to the user.

It is understood that although certain examples refer to a user's location, profile, and the like, the locations and profiles of multiple users may be determined and accessed. For example, if a user has purchased a set of event tickets for the user and friends, images of individuals in the group and/or the group as a whole may be captured, and each user may receive the communication discussed above with respect to step 420, which each user may receive the same set of images or may receive different sets of images (which may include one or more common images as well as non-common images). Each user may perform their own object customization using the received images.

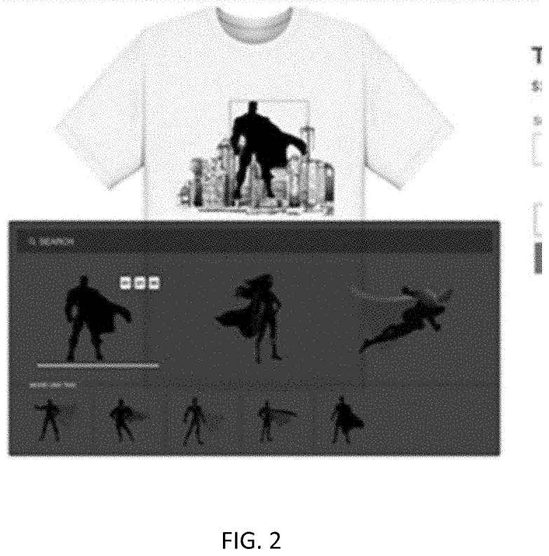

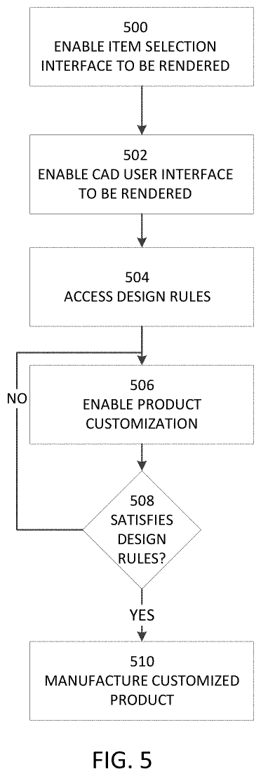

FIG. 5 illustrates example operations that may be performed with respect to an end user in customizing an item using image from a venue of the user, performers, and/or other objects. At block 500, an interactive item selection interface may be enabled to be rendered on a user device (e.g., via a browser or dedicated application). The interactive item selection interface may display or provide access to a catalog of items and a user item selection is received. At block 502, a computer aided design (CAD) user interface is enabled to be rendered on the user device. For example, the CAD user interface may display an image of the item selected by a user, a default template, and a gallery of content that the user may select from (which may include images received in the communication from the system, such as images of the user at the venue and other images from the venue, and may further include images that are not from the venue and other content items, such as text, team logos, band logos, etc.). An example CAD user interface is illustrated in FIG. 2.

At block 504, customization rules and permissions are accessed from memory. For example, the customization rules and permissions may indicate what images may be combined with what other images (e.g., whether images of players from different sports teams may be used together to customize the item, whether logos from different teams may be used together, etc.), what colors may be used for the item, for each design area, for each image in a design area, and/or for each item of text in a design area. By way of further example, the customization rules and permissions may indicate what text formatting (e.g., which fonts, alignment, spacing, size, and/or effects) may be used for an item or for a given design area on the item. By way of yet example, the customization rules and permissions may indicate whether a design element (e.g., text or an image) may be rotated, may specify rotation increments, and/or may specify a maximum rotation amount. By way of yet example, the customization rules and permissions may indicate which design elements (e.g., text or image) that had been applied by an item provider to an item may be deleted or edited. Other example rules and their utilization are described in in U.S. application Ser. No. 16/690,029, filed Nov. 20, 2019, titled COMPUTER AIDED SYSTEMS AND METHODS FOR CREATING CUSTOM PRODUCTS, now U.S. Pat. No. 10,922,449, the contents of which are incorporated herein in their entirety by reference.

At block 506, the user may customize the selected item using the CAD interface. For example, the user may added images (e.g., images of the user and performers taken at a venue as discussed above), logos, text and/or other design elements accessible to the user via the CAD interface. In addition, the user may optionally be enabled to change the item color, resize design elements, drag/move design elements, and/or the like. Optionally, the user may only be enabled to utilize images of the user and/or performers to customize an object for a certain time period relative to the venue event (e.g., during the venue event, within 7 days of the event, etc.). Optionally, after the time period, the corresponding user and/or performer images may not be made accessible to and/or viewable by the user via the interface.

At block 508, the user customizations may be analyzed and a determination made as to whether the user customizations comply with the design rules. If the user customizations are determined not to comply with the design rules, a corresponding notification may be generated and provided for rendering on the user device. If the user customizations are determined to comply with the design rules, the item may be accordingly customized and provided to the user.

For example, one or more files including the item data and/or the customization data may be transmitted over a network to printing machine for printing. At block 510, the customized design elements may be printed or embroidered on the item. For example, the printer may use heat transfer vinyl, screen printing, direct to garment printing, sublimation printing, and/or transfer printing. By way of further example, the printer may be a 3D printer that prints the customized item.

Thus, aspects of the disclosure relate to enhancement in the computer aided design and customization of physical and digital items.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integer to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the phrase “click” may be used with respect to a user selecting a control, menu selection, or the like, other user inputs may be used, such as voice commands, text entry, gestures, etc. For example, a click may be in the form of a user touch (via finger or stylus) on a touch screen, or in the form of a user moving a cursor (using a mouse of keyboard navigation keys) to a displayed object and activating a physical control (e.g., a mouse button or keyboard key). User inputs may, by way of example, be provided via an interface or in response to a prompt (e.g., a voice or text prompt). By way of example an interface may include text fields, wherein a user provides input by entering text into the field. By way of further example, a user input may be received via a menu selection (e.g., a drop down menu, a list or other arrangement via which the user can check via a check box or otherwise make a selection or selections, a group of individually selectable icons, a menu selection made via an interactive voice response system, etc.). When the user provides an input or activates a control, a corresponding computing system may perform a corresponding operation (e.g., store the user input, process the user input, provide a response to the user input, etc.). Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise.

The user terminals described herein may be in the form of a mobile communication device (e.g., a cell phone, a VoIP equipped mobile device, etc.), laptop, tablet computer, interactive television, game console, media streaming device, head-wearable display, virtual reality display/headset, augmented reality display/headset, networked watch, etc. The user terminals may optionally include displays, user input devices (e.g., touchscreen, keyboard, mouse, voice recognition, etc.), network interfaces, etc.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

What is claimed is:

1. A computer-aided design (CAD) computer system comprising:
a computing device;
a network interface;
a non-transitory data media configured to store instructions that when executed by the computing device, cause the computing device to perform operations comprising:
detect a user's presence at a venue;
determine a location associated with the user at the venue;
orient one or more cameras to view the determined location associated with the user at the venue;
capture an image of the determined location associated with the user;
capture images of one or more performers at the venue;
enable the user to access the image of the determined location associated with the user and images of one or more performers at the venue via a CAD customization interface;
provide, for display on a device of the user, a design customization user interface enabling the user to access a first template comprising a plurality of design areas for use in object customization;
enable the user to access the image of the determined location associated with the user and images of one or more performers at the venue via the design customization user interface; and
enable the user to customize an object via the design customization user interface using the template, the image of the determined location associated with the user, and at least one performer image.

2. The CAD computer system as defined in claim 1, the operations further comprising:
scanning a venue admission token associated with the user;
using the scan of the venue admission token to access location information associated with the user;
analyzing a first image of the user location;
determining whether the user is present in the first image of the user location;
at least partly in response to determining that the user is not in the first image of the user location inhibiting the provision to the user of the first image of the user location;
accessing a profile of the user;
determining from the profile user performer preferences;
using the user performer preferences to select one or more performer images taken at the venue while the user was present at the venue; and
enable the user to use the selected performer images to customize the object.

3. The CAD computer system as defined in claim 1, the operations further comprising:
analyzing a first image of the user location;
determining whether the user is present in the first image of the user location;
at least partly in response to determining that the user is not in the first image of the user location inhibiting the provision to the user of the first image of the user location.

4. The CAD computer system as defined in claim 1, the operations further comprising:
accessing a profile of the user;
determining from the profile user performer preferences;
using the user performer preferences to select one or more performer images taken at the venue while the user was present at the venue;
enable the user to use the selected performer images to customize the object.

5. The CAD computer system as defined in claim 1, the operations further comprising:
accessing a profile of the user;
detecting an action being performed at the venue by the performer;
at least partly in response to detecting action being performed at the venue by the performer, causing an image of the user to be captured using a venue camera.

6. The CAD computer system as defined in claim 1, the operations further comprising:
enabling the object customized by the user to be displayed on a display in the venue.

7. The CAD computer system as defined in claim 1, the operations further comprising:
performing face recognition to determine if the user appears in the image of the user location.

8. The CAD computer system as defined in claim 1, the operations further comprising:
using a neural network comprising an input layer and one or more hidden layers to determine if the user appears in the image of the user location.

9. The CAD computer system as defined in claim 1, the operations further comprising:
scanning a venue admission token associated with the user;
using the scan of the venue admission token to access location information associated with the user.

10. The CAD computer system as defined in claim 1, the operations further comprising:
scanning a venue admission token associated with the user;
using the scan of the venue admission token to access location information associated with the user.

11. The CAD computer system as defined in claim 1, the operations further comprising:
examining at least one image of the user location;
at least partly in response to determining that the at least one image of the user location fails to satisfy a first image criterion, deleting the at least one image of the user location from memory.

12. A computer implemented method, the method comprising:
detecting a user's presence at a venue;
determining a location associated with the user at the venue;
capturing an image of the determined location associated with the user;
capturing images of one or more performers at the venue;
enabling the user to access the image of the determined location associated with the user and images of one or more performers at the venue via an object customization interface displayed on a user device;
enabling the user to access a first template comprising one or more design areas for use in object customization;
enable the user to access the image of the determined location associated with the user and images of one or more performers at the venue via the object customization interface; and
enable the user to customize an object via the object customization interface using the template, the image of the determined location associated with the user, and at least one performer image.

13. The computer implemented method as defined in claim 12, the method further comprising:
scanning a venue admission token associated with the user;
using the scan of the venue admission token to access location information associated with the user;
analyzing a first image of the user location;
determining whether the user is present in the first image of the user location;
at least partly in response to determining that the user is not in the first image of the user location inhibiting the provision to the user of the first image of the user location;
accessing a profile of the user;
determining from the profile user performer preferences;
using the user performer preferences to select one or more performer images taken at the venue while the user was present at the venue; and
enable the user to use the selected performer images to customize the object.

14. The computer implemented method as defined in claim 12, the method further comprising:
analyzing a first image of the user location;
determining whether the user is present in the first image of the user location;
at least partly in response to determining that the user is not in the first image of the user location inhibiting the provision to the user of the first image of the user location.

15. The computer implemented method as defined in claim 12, the method further comprising:
accessing a profile of the user;
determining from the profile user performer preferences;
using the user performer preferences to select one or more performer images taken at the venue while the user was present at the venue;
enable the user to use the selected performer images to customize the object.

16. The computer implemented method as defined in claim 12, the method further comprising:
accessing a profile of the user;
detecting an event at the venue involving a performer;
at least partly in response to detecting the event at the venue involving the performer, causing an image of the user to be captured using a venue camera.

17. The computer implemented method as defined in claim 12, the method further comprising:
enabling the object to be displayed on a display in the venue.

18. The computer implemented method as defined in claim 12, the method further comprising:
using a neural network comprising an input layer, one or more hidden layers to determine if the user appears in the image of the user location.

19. The computer implemented method as defined in claim 12, the method further comprising:
performing face recognition to determine if the user appears in the image of the user location.

20. The computer implemented method as defined in claim 12, the method further comprising:
scanning a venue admission token associated with the user; and
using the scan of the venue admission token to access location information associated with the user.

21. The computer implemented method as defined in claim 12, the method further comprising:
scanning a venue admission token associated with the user;
using the scan of the venue admission token to access location information associated with the user.

22. The computer implemented method as defined in claim 12, the method further comprising:
examining at least one image of the user location;
at least partly in response to determining that the at least one image of the user location fails to satisfy a first image criterion, deleting the at least one image of the user location from memory.
